(19) United States
(12) Patent Application Publication
(10) Pub. No.: US 2014/0020186 A1
(43) Pub. Date: Jan. 23, 2014

(54) PRESSURE-REGULATABLE PRESSURE SORES PREVENTION CUSHION

(71) Applicants: Xi' an Jiaotong University, Shaanxi Province (CN); Shanghai Chuangshi Industry (Group) Co., Ltd., ShangHai (CN)

(72) Inventors: Litao Fan, ShangHai (CN); Yong You, ShangHai (CN); Yu Wang, Shaanxi Province (CN); Jianshu Tian, ShangHai (CN); Sujiao Li, Shaanxi Province (CN); Le Li, ShangHai (CN); Jin Li, Shaanxi Province (CN); Xiaolong Peng, Shaanxi Province (CN); Tong Zhang, Shaanxi Province (CN)

(21) Appl. No.: 13/939,979

(22) Filed: Jul. 11, 2013

(30) Foreign Application Priority Data
Jul. 18, 2012 (CN) CN 201210249426.1
Jul. 18, 2012 (CN) CN 201210249526.4

(51) Int. Cl. A61G 5/10

(52) U.S. Cl. CPC A61G 5/10
USPC 5/654

(57) ABSTRACT

A pressure-regulatable pressure sores prevention cushion is provided. The cushion comprises an air cell array, having a plurality of air cells and being divided into at least four air cell zones, the air cells in each air cell zone being in communication with each other, but air cells in any two adjacent air cell zones being not in communication with each other; a plurality of air passages, located under the air cell array and each of which being connected to and in communication with at least one of the air cell zones; a base, on which the air cell array having a plurality of air cells and the air passages being disposed; a plurality of air ducts, which are disposed within the base, an end of each air duct being in communication with a corresponding air passage, and the other end extending out of the cushion and being provided with a joint, and each air duct having a respective valve; and an automatic pressure regulator, which is in communication with the joints of the plurality of air ducts and electrically connected to the respective valve of each duct to enable the automatic pressure regulator to inflate or deflate each air duct.

### CLAIM OF PRIORITY

This application claims the benefit of priority of Chinese Patent Application Serial Number 201210249426.1, entitled “PRESSURE-REGULATABLE PRESSURE SORES PREVENTION CUSHION,” filed on Jul. 18, 2012, and of Chinese Patent Application Serial Number 201210249526.4, entitled “PRESSURE-REGULATABLE PRESSURE SORES PREVENTION CUSHION,” filed on Jul. 18, 2012, the benefit of priority of each of which is claimed hereby, and which is incorporated by reference herein in their entirety.

### FIELD

The present invention relates to a cushion, and in particular, to a pressure-regulatable pressure sores prevention cushion for those who are ill or injured and need to keep a sitting posture for sustained periods of time.

### BACKGROUND

Pressure sores are nerve malnutrition and blood circulation disorder caused by long-term pressure or long-term physical and chemical stimulus on local body tissues. Continuous ischemia, anoxia, and malnutrition of the local tissues cause the skin to lose normal functions and lead to festering and necrosis of soft tissues. For instance, vertical pressure, or shear and friction on local tissues may cause pressure sores, and usually, pressure sores are caused by two to three joint forces.

Pressure sores, which are not primary diseases but belong to common clinical complications, are injuries caused by other primary diseases without good care. Pressure sores not only bring considerable physical and mental sufferings and economic burden to the patients but also increase the workload of nurses, and even worse, may lead to secondary infection and trigger septicemia, hence becoming life-threatening.

Most pressure sores can be prevented. However, in practical cases of illness, moisture, heat, age, and obesity all significantly increase the incidence of pressure sores. Therefore, people use various methods to prevent pressure sores. At present, division-type air rings, pressure sores prevention cold liquid cushions or other composite cushions are mainly used to prevent pressure sores, but all these products are flawed in that the cushion continuously exerts pressure on the body, and cannot maintain a stable shell temperature.

In addition, as shown in FIG. 1A and FIG. 1B, the U.S. Pat. No. 5,052,068 discloses a contoured cushion, which provides a plurality of air cells on a flexible base 2. The air cells include short cells 4, intermediate cells 6, and long cells 8 that are organized into an outer zone x and an inner zone y; the air cells of the outer zone x are in communication with each other, the air cells of the inner zone y are in communication with each other, but the air cells of the outer zone x are not in communication with the air cells of the inner zone y. Once the user sits on the cushion, he or she can open the valves 42 and 44 respectively in communication with the outer zone x and the inner zone y to release the pressure in the air cells of the inner zone x and the outer zone y, thereby adjusting the height of each air cells in the zones, so as to be more in conformance with the shape of human buttocks on the cushion; hence, the user gets the most comfortable sitting posture and experience.

Moreover, as shown in FIG. 2A and FIG. 2B, the U.S. Pat. No. 5,502,855 discloses a cellular cushion, which provides a plurality of air cells on a base 2 thereof. The air cells are divided into four zones, namely, r, s, t, and u zones; air cells in each zone are in communication therebetween, and the four zones can be communicated through a manifold 24. Moreover, communication among the four zones can be cut off by closing separate air ducts 20, 21, 22, and 23. Before the cushion is used, the air cells in the zones are inflated by means of an inflating air valve 26, and at this time, the clip-type hose valve 30 is open, that is, the r, s, t, and u zones are in communication through the manifold 24. After sufficient air is charged into the cushion, the inflating air valve 26 is closed. Then, the user sits on the cushion, and air is slowly released through the inflating air valve 26. As the air is being released, the buttocks of the user sink into the air cells, and when reaching a desired sinking depth, the user closes the inflating air valve 26. In addition, the user can close the separate air ducts 20, 21, 22, and 23 so as to prevent air from flowing among the four zones. This patent has similar advantages as the patent described previously, i.e., the user can release air so that the cushion is more in conformance with the shape of body, thereby obtaining the most comfortable sitting posture and experience.

When being used by those who need to keep a sitting posture for a long time, the cushions in the above two patents can provide very comfortable sitting posture and experience, yet pressure is applied to the body continuously, and pressure sores are still very likely to occur.

### SUMMARY

In view of the disadvantages of the prior art, the present invention is to provide a pressure-regulatable pressure sores prevention cushion, which inflates and deflates different air cell zones in an alternating manner, so as to avoid continuously applying pressure on a certain part of the human body, thereby reducing the occurrence probability of pressure sores.

To achieve the objective, the technical solution of the present invention provides a pressure-regulatable pressure sores prevention cushion, which may includes: an air cell array having a plurality of air cells and being divided into at least four air cell zones, the air cells in each air cell zone being in communication with each other, but the air cells in any two adjacent air cell zones being not in communication with each other; a plurality of air passages disposed under the air cell array, each air passage being in connection and communication with at least one of the air cell zones; a base, on which the air cell array having the plurality of air cells and the plurality of air passage layer are disposed; a plurality of air ducts disposed within the base, an end of each air duct being in communication with a corresponding air passage, and the other end extending out of the cushion and being provided with a joint, and each air duct having a respective valve; and an automatic pressure regulator which is in fluid communication with the joint of the plurality of air ducts and electrically connected to the respective valve of each duct to enable the automatic pressure regulator to inflate or deflate each air duct.

Preferably, the automatic pressure regulator may includes: a microprocessor; a control panel on which a display device and a plurality of regulation buttons are disposed, the display device and the plurality of regulation buttons being electrically connected with microprocessor; and an inflate device and a deflate device which are electrically connected with the microprocessor and controlled by the microprocessor, and the inflate device and the deflate device being in communication with the respective joint of the plurality of air ducts, wherein the microprocessor is electrically connected with the respective valve of each air duct and may control the open and close of each valve.

To achieve the above objective, the present invention further provides a pressure-regulatable pressure sores prevention cushion, which may includes: an air cell array having a plurality of air cells and being divided into at least four air cell zones, the air cells in respective air cell zone being in communication with each other, but the air cells in any two adjacent air cell zones being not in communication with each other; a plurality of air passages disposed under the air cell array, each air passage being in connection and communication with at least one of the air cell zones; a base, on which the air cell array having the plurality of air cells and the plurality of air passage layer are disposed; a plurality of air ducts disposed within the base, one end of each air duct being in communication with the corresponding air passage, and the other end extending out of the cushion and being provided with a joint, and each air duct having a respective valve; and a manual inflating device which is in fluid communication with each joint of the plurality of air ducts to inflate the air ducts via the manual inflating device.

Preferably, the manual inflating device may be in fluid communication with each joint of the plurality of air ducts by a directional control valve.

Still preferably, the number of the air passages may be less than the number of the air cell zones.

In an embodiment of the present invention, the air cell array may be sequentially divided clockwise into four air cell zones with equal areas, namely, an A air cell zone, a B air cell zone, a C air cell zone, and a D air cell zone; the number of the air passages are two, namely, a first air passage and a second air passage, wherein the first air passage is in connection and communication with the A air cell zone and the C air cell zone, and the second air passage is in connection and communication with the B air cell zone and the D air cell zone.

In another embodiment of the present invention, the air cell array may be divided into an A air cell zone, a B air cell zone, a C air cell zone, a D air cell zone, and an E air cell zone as arranged in an array below; the plurality of air passages have a first air passage, a second air passage, and a third air passage; wherein the first air passage is in connection and communication with the A air cell zone and the C air cell zone, the second air passage is in connection and communication with the B air cell zone and the D air cell zone, and the third air passage is in connection and communication with the E air cell zone; the array is shown as follows:

$$[ \begin{matrix}E & E & E & E & E & E & E & E & E & E \\ E & E & E & E & E & E & E & E & E & E \\ A & A & A & A & A & B & B & B & B & B \\ A & A & A & A & A & B & B & B & B & B \\ A & A & A & A & A & B & B & B & B & B \\ A & A & A & A & A & B & B & B & B & B \\ D & D & D & D & D & C & C & C & C & C \\ D & D & D & D & D & C & C & C & C & C \\ D & D & D & D & D & C & C & C & C & C \\ D & D & D & D & D & C & C & C & C & C\end{matrix} ] .$$

In still another embodiment of the present invention, the air cell array may be divided into an A1 air cell zone, an A2 air cell zone, an A3 air cell zone, an A4 air cell zone, a B1 air cell zone, a B2 air cell zone, a B3 air cell zone, a B4 air cell zone, a C air cell zone, a D air cell zone, and an E air cell zone as arranged in an array below; wherein the plurality of air passages have a first air passage, a second air passage, a third air passage, a fourth air passage, and a fifth air passage therein; wherein the first air passage is in connection and communication with the A1, A2, A3, and A4 air cell zones, the second air passage is in connection and communication with the B1, B2, B3, and B4 air cell zones, the third air passage is in connection and communication with the C air cell zone, the fourth air passage is in connection and communication with the D air cell zone, and the fifth air passage is in connection and communication with the E air cell zone; the array is shown as follows:

$$[ \begin{matrix}E & E & E & E & E & E & E & E & E & E \\ E & E & E & E & E & E & E & E & E & E \\ A 4 & A 4 & A 4 & A 4 & A 4 & B 4 & B 4 & B 4 & B 4 & B 4 \\ A 4 & A 4 & A 4 & A 4 & A 4 & B 4 & B 4 & B 4 & B 4 & B 4 \\ B 3 & B 3 & B 3 & B 3 & B 3 & A 3 & A 3 & A 3 & A 3 & A 3 \\ B 3 & B 3 & B 3 & B 3 & B 3 & A 3 & A 3 & A 3 & A 3 & A 3 \\ A 1 & A 1 & D & D & D & D & D & D & B 1 & B 1 \\ A 1 & A 1 & D & D & D & D & D & D & B 1 & B 1 \\ A 1 & A 1 & B 2 & B 2 & C & C & A 2 & A 2 & B 1 & B 1 \\ A 1 & B 2 & B 2 & B 2 & C & C & A 2 & A 2 & A 2 & B 1\end{matrix} ] .$$

In still another embodiment of the present invention, the air cell array may be divided into an A1 air cell zone, an A2 air cell zone, an A3 air cell zone, a B1 air cell zone, a B2 air cell zone, a B3 air cell zone, a C air cell zone, a D air cell zone, an E air cell zone, and a F air cell zone as arranged in an array below; the plurality of air passages have a first air passage, a second air passage, a third air passage, a fourth air passage, a fifth air passage, and a sixth air passage therein; wherein the first air passage is in connection and communication with the A1, A2, and A3 air cell zones; the second air passage is in connection and communication with the B1, B2, and B3 air cell zones, the third air passage is in connection and communication with the C air cell zone, the fourth air passage is in connection and communication with the D air cell zone, the fifth air passage is in connection and communication with the E air cell zone, and the sixth air passage is in connection and communication with the F air cell zone; the array is shown as follows:

$$[ \begin{matrix}E & E & E & E & E & E & E & E & E & E \\ E & E & E & E & E & E & E & E & E & E \\ A 3 & A 3 & A 3 & A 3 & A 3 & B 3 & B 3 & B 3 & B 3 & B 3 \\ A 3 & A 3 & A 3 & A 3 & A 3 & B 3 & B 3 & B 3 & B 3 & B 3 \\ B 2 & B 2 & B 2 & B 2 & B 2 & A 2 & A 2 & A 2 & A 2 & A 2 \\ B 2 & B 2 & B 2 & B 2 & B 2 & A 2 & A 2 & A 2 & A 2 & A 2 \\ A 1 & A 1 & C & C & C & D & D & D & B 1 & B 1 \\ A 1 & A 1 & C & C & C & D & D & D & B 1 & B 1 \\ A 1 & A 1 & C & C & F & F & D & D & B 1 & B 1 \\ A 1 & C & C & C & F & F & D & D & D & B 1\end{matrix} ] .$$

In other embodiments of the present invention, the air cell array may be divided into an A1 air cell zone, an A2 air cell zone, an A3 air cell zone, an A4 air cell zone, an A5 air cell zone, a B1 air cell zone, a B2 air cell zone, a B3 air cell zone, a B4 air cell zone, a B5 air cell zone, and a C air cell zone as arranged in an array below; the plurality of air passages have a first air passage, a second air passage, and a third air passage therein; wherein the first air passage is in connection and communication with the A1, A2, A3, A4, and A5 air cell zones, the second air passage is in connection and communication with the B1, B2, B3, B4, and B5 air cell zones, and the third air passage is in connection and communication with the C air cell zone; the array is shown as follows:

$$[ \begin{matrix}C & C & C & C & C & C & C & C & C & C \\ C & C & C & C & C & C & C & C & C & C \\ B 5 & B 5 & B 5 & B 5 & B 5 & A 5 & A 5 & A 5 & A 5 & A 5 \\ B 5 & B 5 & B 5 & B 5 & B 5 & A 5 & A 5 & A 5 & A 5 & A 5 \\ A 4 & A 4 & A 4 & A 4 & A 4 & B 4 & B 4 & B 4 & B 4 & B 4 \\ A 4 & A 4 & A 4 & A 4 & A 4 & B 4 & B 4 & B 4 & B 4 & B 4 \\ B 3 & B 3 & B 3 & B 3 & {}_{B 3}^{ }{\backslash}{}_{ }^{A 4} & {}_{ }^{B 4}{/}{}_{A 3}^{ } & A 3 & A 3 & A 3 & A 3 \\ B 3 & A 1 & B 3 & B 3 & {}_{ }^{B 3}{/}{}_{A 2}^{ } & {}_{B 2}^{ }{\backslash}{}_{ }^{A 3} & A 3 & A 3 & B 1 & A 3 \\ A 1 & A 1 & B 3 & B 3 & A 2 & B 2 & A 3 & A 3 & B 1 & B 1 \\ A 1 & B 3 & B 3 & B 3 & A 2 & B 2 & A 3 & A 3 & A 3 & B 1\end{matrix} ] .$$

Preferably, each air cell in the air cell array may be a columnar air cell; the columnar air cell includes a columnar outer casing layer and an air cell column disposed in the outer casing layer; the air cell column may be any one or any combination of a spring, a sponge, cotton, and a foam plate; more preferably, the air cell column is directly formed by foaming a sponge, which has highly fitting and firm performance, and meanwhile improves the overall stability of the air cell and helps maintain the shape of the air cell. Moreover, a hydrogel layer is disposed at the top of the air cell column, a sealing layer is disposed between the top of the air cell column and the hydrogel layer, and air is filled in space among the outer casing layer, the air cell column, and the sealing layer. The sealing layer tightly contacts an inner wall of the outer casing layer, so that the directly formed hydrogel does not fall off or leak under the effect of gravity and extrusion of a human body.

The top of the outer casing layer may be an upwardly protruding arc surface, which reduces edges and corners and increases a contact area. When the body contacts the arc-shaped hydrogel layer at the top, no discomfort or pains is aroused.

The columnar air cell is shaped into any one of a cylinder, a prism, a cube, a cuboid or a combination thereof.

A cross section of the columnar air cell is shaped into a four-pointed star, and a periphery of the columnar air cell is arc-shaped.

The present invention has following advantages: the air cell array is divided into different air cell zones in cross distribution, and the pressure of air cells in the air cell zones and the pressure lasting period are controlled so that pressure is intermittently exerted over the buttocks of the human body, thereby preventing blood circulation of the skin from being blocked. Furthermore, owing to the hydrogel layer above the air cell columns and the sealing layer between the top of the air cell columns and the hydrogel layer, the columnar air cells are protected from thorough damage, and have multiple protection functions. The hydrogel layer and a constant-temperature phase transition material in the columnar air cells maintain a comfortable temperature at the surface of buttocks of the user, so that the user feels cool and a desirable pressure equalizing effect is generated. Meanwhile, the upwardly protruding arc-shaped hydrogel layer does not have any sharp edges or corners thereon, contributing to a greater contact area, thereby avoiding the problem of concentrated stress caused by the acute angle, and dispersing the load, so that the user does not feel pain during long-time contact. The periphery of the columnar air cell is arc-shaped, which enhances and fully brings out the mechanical strength of the cushion, and improves the fluidity of the plastic melt, thereby facilitating the filling and demolding, eliminating defects such as the concave at the turning part of the wall, and facilitating the machining and thermal treatment of the mold; hence, the service life of mold is improved. The air cell column has a function of maintaining a stable air cell shape, and will not collapse and hence be damaged due to insufficient stability.

### DRAWINGS

FIG. 1A is a perspective schematic view showing a cushion in the prior art;

FIG. 1B is a schematic view showing distribution of air cell zones of the cushion shown in FIG. 1A;

FIG. 2A is a perspective schematic view showing another cushion in the prior art;

FIG. 2B is a schematic view showing distribution of air cell zones of the cushion shown in FIG. 2A;

FIG. 3 is a perspective exploded schematic view showing the present invention;

FIG. 4 is a schematic view showing distribution of air cell zones according to a first embodiment of the present invention;

FIG. 5A is a schematic view showing connection of an automatic pressure regulator in the present invention;

FIG. 5B is a schematic view showing connection of a manual inflating device in the present invention;

FIG. 6 is an enlarged perspective schematic view showing a columnar air cell in the present invention;

FIG. 7 is an enlarged sectional view showing a columnar air cell in the present invention;

FIG. 8 is an enlarged cross section showing a columnar air cell in the present invention;

FIG. 9 is an enlarged cross section showing a first variant structure of a columnar air cell in the present invention;

FIG. 10 is an enlarged cross section showing a second variant structure of a columnar air cell in the present invention;

FIG. 11 is a schematic view showing distribution of air cell zones according to a second embodiment of the present invention;

FIG. 12 is a schematic view showing distribution of air cell zones according to a third embodiment of the present invention;

FIG. 13 is a schematic view showing distribution of air cell zones according to a fourth embodiment of the present invention; and

FIG. 14 is a schematic view showing distribution of air cell zones according to a fifth embodiment of the present invention.

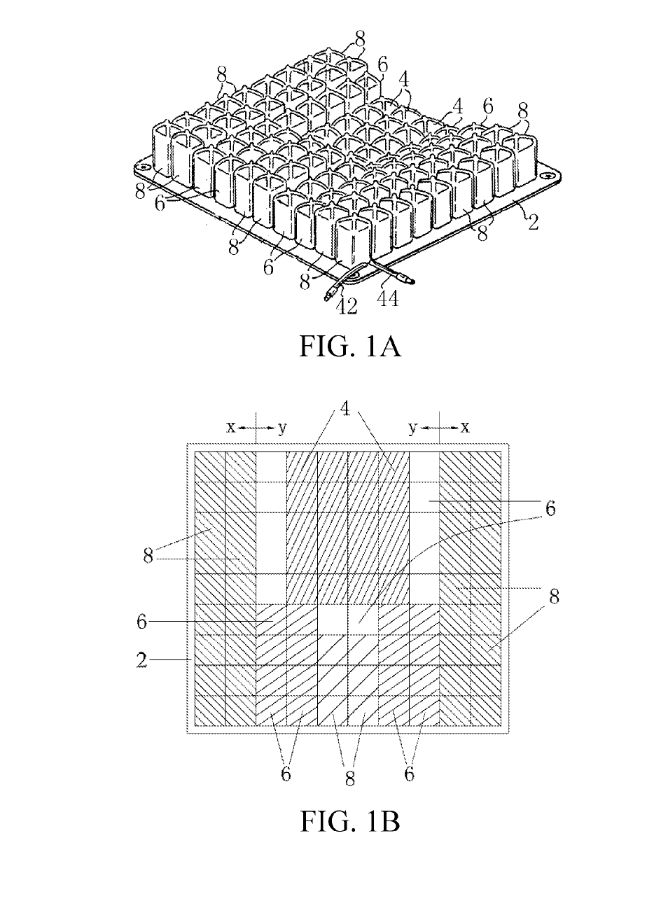

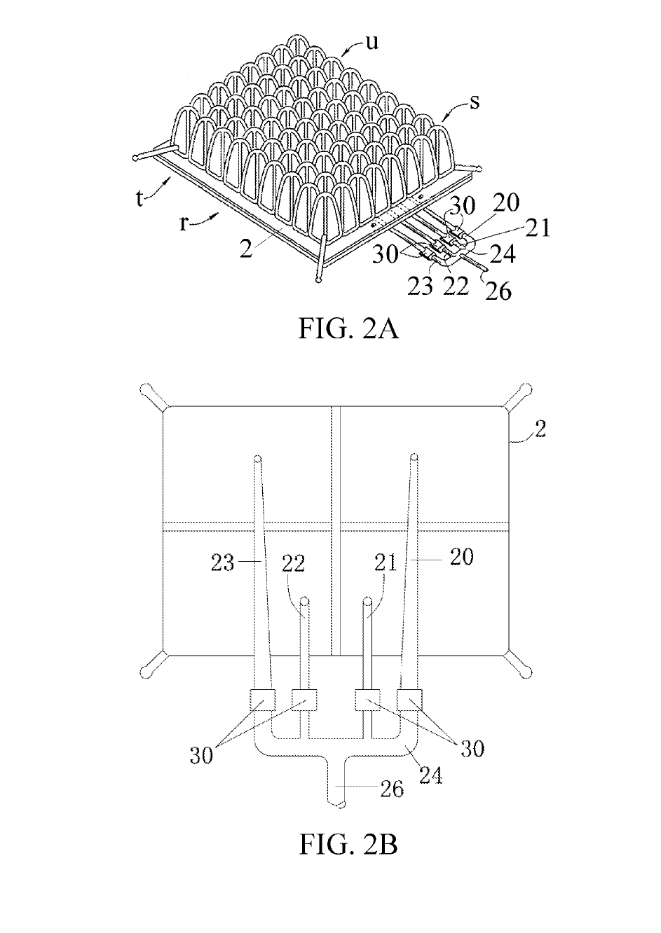

### DETAILED DESCRIPTION OF THE INVENTION

The technical solution employed in the present invention to achieve the objective is further illustrated in the following with reference to the accompanying drawings and embodiments of the present invention.

The technical solution employed in the present invention provides a pressure-regulatable pressure sores prevention cushion, which includes: an air cell array having a plurality of air cells and being divided into at least four air cell zones, air cells in each air cell zone being in communication with each other, but air cells in any two adjacent air cell zones being not in communication with each other;

a plurality of air passages located under the air cell array, each air passage being in connection and communication with at least one of the air cell zones;
a base on which the air cell array having a plurality of air cells and, the plurality of air passages are disposed;
a plurality of air ducts disposed in the base, each air duct having an end communicating with a corresponding air passage, and having another end extending out of the cushion and providing a joint; each air duct having a respective valve; and
an automatic pressure regulator, which is in communication with the joint of the plurality of air ducts and being electrically connected with the respective valve of each of air ducts to enable the automatic pressure regulator to inflate or deflate each air duct.

In the embodiments of the present invention, the automatic pressure regulator auto-pressure-regulation device includes: a microprocessor; a control panel on which a display device and a plurality of regulation button are disposed, the display device and the plurality of regulation button being electrically connected with the microprocessor; an inflate device and a deflate device, which are electrically connected with and controlled by the microprocessor, and the inflate device and the deflate device are in fluid communication with each joint of the plurality of air ducts; wherein the microprocessor is electrically connected with the respective valve of each air duct and may control the open and close of each valve.

It will be appreciated for those skilled in the art that the microprocessor may control the inflating device and deflating device and cooperate with the valve so as to inflate or deflate the cushion through the air ducts. In practical implementation, the inflating device may be a controlled electric inflating device (such as an air pump), and the deflating device may be a controlled electric deflating device (such as an air pump), so as to be electrically connected with the microprocessor for inflation and deflation.

Alternatively, in the present invention, it is possible to utilise a manual inflating device instead of the automatic pressure regulator, the manual inflating device is in fluid communication with the joints of the plurality of air ducts to inflate the cushion via the manual inflating device.

It will be appreciated for those skilled in the art that the manual inflating device may be the conventional inflating device which is commercial available or customized, e.g., inflator, pedal inflator or squeezing inflator. Also, the manual inflating device may cooperate with the valve to inflate the different air cell zone of the cushion through the air ducts. For example, to inflate one certain air cell zone or several air cell zones, it is possible to open the valve of the air duct connected manually, and operate the manual inflating device to inflate one or several air cell zones, and then close the valve after inflating. To deflating one certain air cell zone or several air cell zones, it is possible to open the valve of the air duct connected manually to exhaust the air from the air cell, or exhaust the air from the air cell by the pressure applied from the user sitting on the cushion.

Further, the manual inflating device may be in fluid communication with the respective joint of the plurality of air ducts by directional control valve (e.g., the directional control valve may be three-position four-way valve, four-position five-way valve, or twelve-position six-way valve). The different directional control valve can be applied in accordance with the different division of the air cell zones, for example, the four-position five-way valve can be applied on the first embodiment of the present invention described-below, the four-position five-way valve can be applied on the second embodiment of the present invention, and the twelve-position six way valve can be applied on the third, fourth and fifth embodiments of the present invention, respectively.

The advantage of using the directional control valve is that the valve can be kept in normally open state in the practical implementation while it is determined, by directional control valve, which air ducts are selected (i.e., which air cell zones are selected) to be in communication with the manual inflating device, and thus the manual inflating device is operated to inflate the air cell zones which are in communication with the selected air ducts (or one air duct is possible); or it is determined, by directional control valve, which air ducts are selected (i.e., which air cell zones are selected) to be deflated.

Furthermore, the number of the air passages is less than the number of the air cell zones in the present invention.

In the first embodiment of the present invention, the air cell array is sequentially divided clockwise into four air cell zones with equal areas, namely, an A air cell zone, a B air cell zone, a C air cell zone, and a D air cell zone; the air passages have two air passages, namely, a first air passage and a second air passage; in which the first air passage is in connection and communication with the A air cell zone and the C air cell zone, and the second air passage is in connection and communication with the B air cell zone and the D air cell zone.

In the second embodiment of the present invention, the air cell array is divided into an A air cell zone, a B air cell zone, a C air cell zone, a D air cell zone, and an E air cell zone; the plurality of air passages have a first air passage, a second air passage, and a third air passage; in which the first air passage is in connection and communication with the A air cell zone and the C air cell zone, the second air passage is in connection and communication with the B air cell zone and the D air cell zone, and the third air passage is in connection and communication with the E air cell zone.

In the third embodiment of the present invention, the air cell array is divided into an A1 air cell zone, an A2 air cell zone, an A3 air cell zone, an A4 air cell zone, a B1 air cell zone, a B2 air cell zone, a B3 air cell zone, a B4 air cell zone, a C air cell zone, a D air cell zone, and an E air cell zone; the plurality of air passages have a first air passage, a second air passage, a third air passage, a fourth air passage, and a fifth air passage; in which the first air passage is in connection and communication with the A1, A2, A3, and A4 air cell zones, the second air passage is in connection and communication with the B1, B2, B3, and B4 air cell zones, the third air passage is in connection and communication with the C air cell zone, the fourth air passage is in connection and communication with the D air cell zone, and the fifth air passage is in connection and communication with the E air cell zone.

In the fourth embodiment of the present invention, the air cell array is divided into an A1 air cell zone, an A2 air cell zone, an A3 air cell zone, a B1 air cell zone, a B2 air cell zone, a B3 air cell zone, a C air cell zone, a D air cell zone, an E air cell zone, and a F air cell zone; the plurality of air passages have a first air passage, a second air passage, a third air passage, a fourth air passage, a fifth air passage, and a sixth air passage; in which the first air passage is in connection and communication with the A1, A2, and A3 air cell zones, the second air passage is in connection and communication with the B1, B2, and B3 air cell zones, the third air passage is in connection and communication with the C air cell zone, the fourth air passage is in connection and communication with the D air cell zone, the fifth air passage is in connection and communication with the E air cell zone, and the sixth air passage is in connection and communication with the F air cell zone.

In the fifth embodiment of the present invention, the air cell array is divided into an A1 air cell zone, an A2 air cell zone, an A3 air cell zone, an A4 air cell zone, an A5 air cell zone, a B1 air cell zone, a B2 air cell zone, a B3 air cell zone, a B4 air cell zone, a B5 air cell zone, and a C air cell zone; the plurality of air passages have a first air passage, a second air passage, and a third air passage; in which the first air passage is in connection and communication with the A1, A2, A3, A4, and A5 air cell zones, the second air passage is in connection and communication with the B1, B2, B3, B4, and B5 air cell zones, and the third air passage is in connection and communication with the C air cell zone.

In the above embodiments, each air cell in the air cell array is a columnar air cell; the columnar air cell includes a columnar outer casing layer and an air cell column disposed in the outer casing layer; the outer casing layer is made of the same material and is integrally formed; the wall thickness of the outer casing layer is kept the same from the bottom to the top. The air cell column is directly formed by foaming sponge. Besides, a hydrogel layer is disposed at the top of the air cell column, and the hydrogel layer is directly formed at the top of the air cell column with excellent fitting and adhering performance. Air is filled in space among the outer casing layer, the air cell column, and the sealing layer, and is exchanged with gas inside the air cell, so as to control the humidity and temperature of the air cell. A sealing layer is disposed between the top of the air cell column and the hydrogel layer. The sealing layer tightly contacts an inner wall of the outer casing layer. The sealing layer is made of the same material as the outer casing layer; the sealing layer in tight contact with the inner wall of the outer casing layer may be formed after a secondary vulcanization process, thereby ensuring the tightness, firmness and beauty of the hydrogel layer.

It can be known from the description in the background that when being used by those who need to keep a sitting posture for a long time, the existing two cushions can provide very comfortable sitting position and experience, but still continuously apply pressure to the body, and therefore are still very likely to trigger pressure sores.

The present invention is aimed to improve the cushions in the prior art which cannot intermittently exert pressure over buttocks, and preventing blood circulation of skin from being blocked. Embodiments of the present invention are described in further details below with reference to the accompanying drawings.

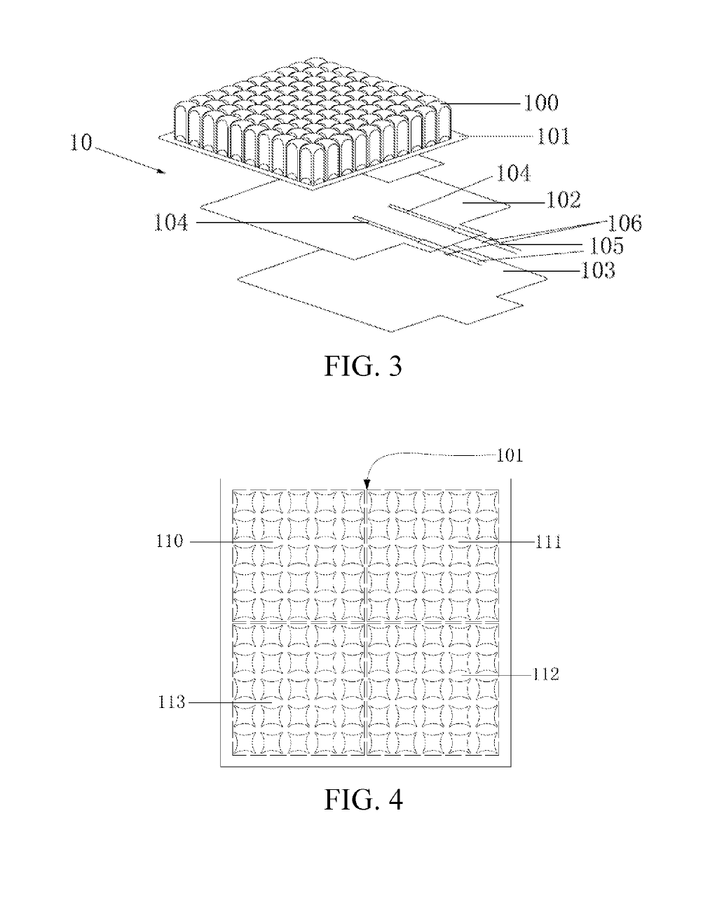

FIG. 3 is a perspective exploded schematic view showing the present invention. As shown in FIG. 3, a pressure sores prevention cushion 10 includes an air cell array 101, an air passages 104, and a base 103 arranged sequentially from top down. The air passages 104 and the air cell array 101 are disposed on the base 103. The pressure sores prevention cushion 10 further includes a plurality of air ducts 105. The air cell array 101 has a plurality of air cells 100; in the view, the air cells form a 10×10 air cell array, which, of course, is merely a schematic representation; in actual applications, the air cells may also form a 10×15 array, a 15×15 array, a 15×20 array, or a 20×20 array, and the like.

FIG. 4 is a schematic view showing distribution of air cell zones according to a first embodiment of the present invention. As shown in FIG. 4, the air cell array 101 is divided into four air cell zones with equal areas, namely, an A air cell zone 110, a B air cell zone 111, a C air cell zone 112, and a D air cell zone 113; air cells in each air cell zone are in communication with each other, but air cells in any two adjacent air cell zones are not in communication with each other; further, a first air passage and a second air passage are provided under the air passage 101. In which the A air cell zone 110 is connected to the C air cell zone 112 through the first air passage; and the B air cell zone 111 is connected to the D air cell zone 113 through the second air passage. As shown in FIG. 3, an end of the air duct 105 is in communication with the corresponding air passage 104, and the other end extends out of the cushion and is provided with a joint; and each air duct 105 is provided with a respective valve 106.

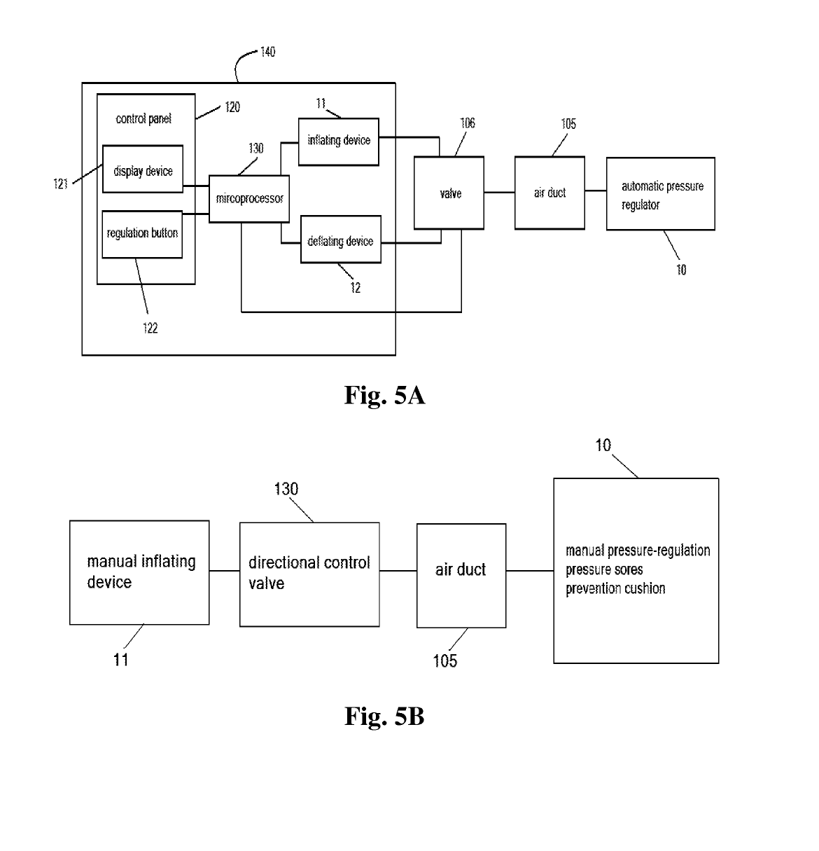

As shown in FIG. 5A, the pressure-regulatable pressure sores prevention cushion may comprises the automatic pressure regulator 140, which includes: a microprocessor 130; a control panel 120 on which a display device 121 and a plurality of regulation button 122 are disposed, the display device 121 and the plurality of regulation button 122 being electrically connected with microprocessor 130; and an inflate device 11a and a deflate device 12, which are electrically connected with the microprocessor 130 and controlled by the microprocessor 130, and the inflate device 11a and the deflate device 12 are fluid connected with each joint 106 of the plurality of air ducts 105; the microprocessor 130 is electrically connected with the respective valve 106 of each air duct 105 and may control the open and close of each valve 106 to inflate and deflate the different air ducts 105 in corporation with the inflate device 11a and the deflate device 12, that is, so as to implement the inflating and deflating of the different air cells zones. For example, under the control of the automatic pressure regulator, the A air cell zone and C air cell zone are inflated so as to maintain high pressure, and meanwhile the B air cell zone and D air cell zone are deflated so as to maintain low pressure; such a state lasts, for example, 1-10 minutes, and then under the control of the automatic pressure regulator, the B air cell zone and D air cell zone are inflated so as to maintain high pressure, and meanwhile the A air cell zone and C air cell zone are deflated so as to maintain low pressure; such a state also lasts, for example, 1-10 minutes, and then the A air cell zone and C air cell zone are inflated so as to maintain high pressure, and meanwhile the B air cell zone and D air cell zone are deflated so as to maintain low pressure. During the inflating or deflating in the different air cell zones, the regulation can be made according to the different users, for example, the pressure and duration of inflating or deflating can be set and regulated according to the user's mobility and weight by the regulation button on the control panel. Furthermore, the selectively regulation can be made by the parameters displayed on the display device of control panel with respected to the duration of inflating or deflating, pressure in the different air cells and the like. In the exemplary embodiment, an affordable pressure value ranged from 50 to 70 kg can be set; when the pressure of A air cell zone and C air cell zone is lower than 50 kg, the valve corresponding to the A air cell zone and C air cell zone is opened by the microprocessor and the inflating device is controlled by the microprocessor to inflate the A air cell zone and C air cell zone through the air ducts, and when the pressure of A air cell zone and C air cell zone is reached to 70 kg, the inflating device is controlled by the microprocessor to stop inflating the A air cell zone and C air cell zone and the valve corresponding to the A air cell zone and C air cell zone may be closed, maintaining the pressure of 70 kg. Next, after a certain moment in this state, the valve corresponding to the A air cell zone and C air cell zone may be opened to deflate under the effect of the weight of the user, or the deflating device may be activated to rapid deflate, and when the pressure of A air cell zone and C air cell zone is lower than 50 kg (or after a certain moment under the pressure of 50 kg), the inflating device is controlled by the microprocessor to re-inflate the A air cell zone and C air cell zone so that the A air cell zone and C air cell zone are inflated and deflated repeatedly, therefore the body will be alternatively pressurized by this repeating process. The description above is only the exemplary illustration of the pressure regulation in A air cell zone and C air cell zone, and the B air cell zone and D air cell zone can be inflated or deflated in the same manner; in addition, the different duration of inflating or deflating and different pressure of inflating or deflating may be set according to the different air cell zones on the cushion. The inflating or deflating speed in different air cell zones can be a constant value or variable value. The different air cell zones are pressurized in an alternating manner as described so that the pressure is applied in an alternating manner on different parts of buttocks of a person who sits on the cushion for a long time, thereby preventing continuously applying pressure to some part of the body and reducing the occurrence probability of pressure sores.

Furthermore, as shown in FIG. 5B, for the manual pressure-regulation pressure sores prevention cushion 10, the automatic pressure regulator 140 may be replaced by a manual inflating device 11b; the manual inflating device 11b is in fluid communication with the respective joints of the air ducts, alternatively, the manual inflating device 11b may be in fluid communication with the respective joints of the air ducts by the directional control valve 130; FIG. 5B shows an embodiment with the directional control valve; however, it should be understood that it is also available without the directional control valve.

The inflating or deflating in different air cell zones may be performed by the operation of the manual inflating device cooperated with the valve or with the directional control valve described above. For example, the A air cell zone and C air cell zone can be inflated to maintain high pressure therein while the B air cell zone and D air cell zone can be deflated to maintain low pressure therein, lasting such state in 10-60 minute; then the B air cell zone and D air cell zone can be inflated to maintain high pressure therein while the A air cell zone and C air cell zone can be deflated to maintain low pressure therein, such state can be also lasting 10-60 minutes; after that, the A air cell zone and C air cell zone can be re-inflated to maintain high pressure therein while the B air cell zone and D air cell zone can be re-deflated to maintain low pressure therein. The different air cell zones are pressurized (i.e., inflating) in an alternating manner as described so that the pressure is applied in an alternating manner on different parts of buttocks of a person who sits on the cushion for a long time, thereby preventing continuously applying pressure to some part of the body and reducing the occurrence probability of pressure sores.

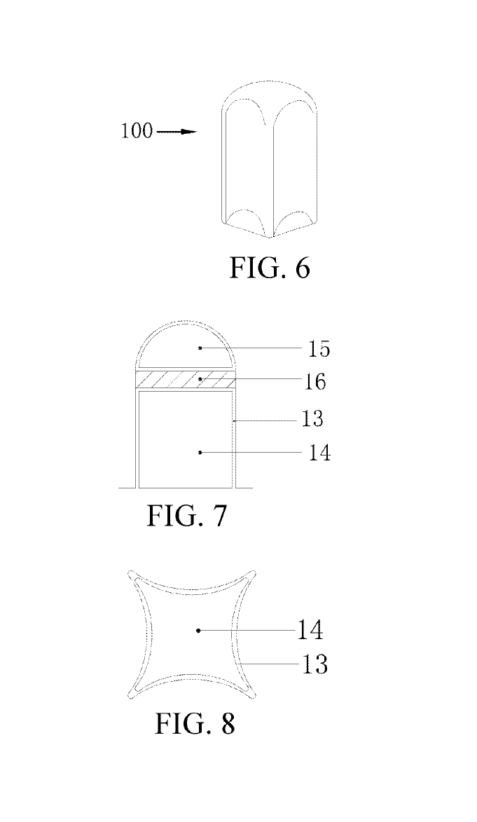

Further, referring to FIG. 6 and FIG. 7, each air cell in the air cell array 101 is a columnar air cell 100, and the columnar air cells 100 can have the same or different lengths. The columnar air cell 100 includes a columnar outer casing layer 13 and an air cell column 14 disposed in the outer casing layer 13; the outer casing layer 13 is made of the same material, and is integrally formed. The wall thickness of the outer casing layer 13 is kept the same from the bottom to the top. The air cell column 14 is directly formed by foaming sponge and has high fitting and firm performance, and meanwhile improves the overall stability of the air cell to help maintain the shape of the air cell. Moreover, a hydrogel layer 15 is disposed at the top of the air cell column 14. The hydrogel layer 15 is directly formed at the top of the air cell column 14, and has excellent fitting and adhering performance. A high-water-content and constant-temperature phase transition material in the hydrogel provides a lasting cool feel. Air is filled in space among the outer casing layer 13, the air cell column 14, and the sealing layer 16, and is exchanged with gas in the air cell so as to control the humidity and temperature of the air cell. The top of the outer casing layer 13 is an upwardly protruding arc surface so as to reduce edges and corners and increase a contact area. When the body contacts the arc-shaped hydrogel layer 15 at the top, no discomfort or pains is aroused.

A sealing layer 16 is disposed between the top of the air cell column 14 and the hydrogel layer 15. The sealing layer 16 tightly contacts an inner wall of the outer casing layer 13. The sealing layer 16 may be made of the same material as the outer casing layer 13; the sealing layer 16 in tight contact with the inner wall of the outer casing layer 13 may be formed after a secondary vulcanization process, thereby ensuring the tightness, firmness and beauty of the hydrogel layer 15, so that the hydrogel directly formed does not fall off or leak under the effect of gravity and extrusion of a body.

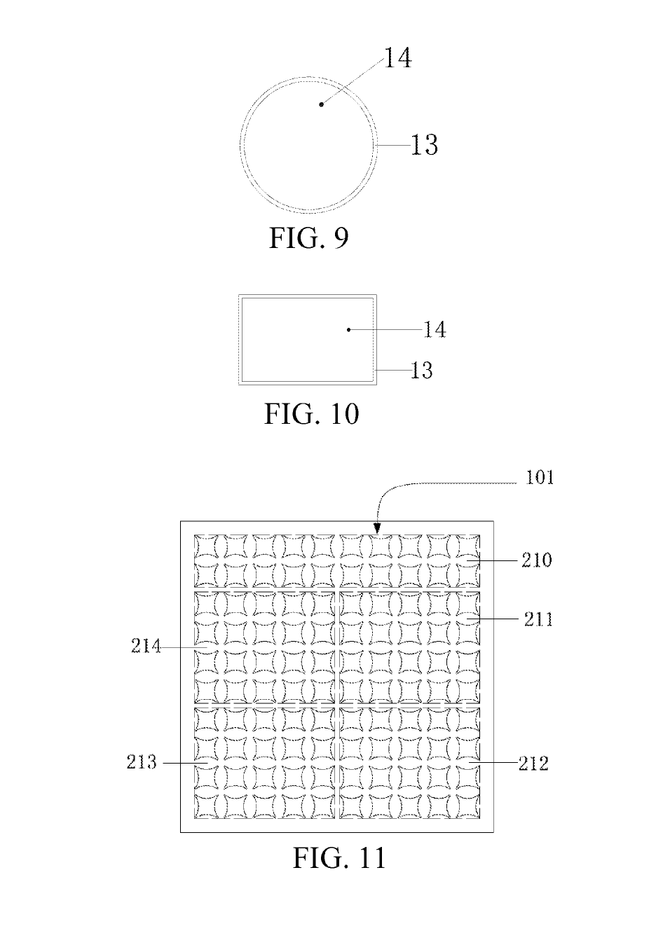

As shown in FIG. 8 to FIG. 10, the cross section of the columnar air cell 100 is shaped into a four-pointed star, a cylinder or a cuboid. Those skilled in the art should know that the cross section of the columnar air cell 100 is not limited to the above three shapes, and may also be shaped into an ellipse, a triangle, a five-pointed star, and the like.

FIG. 11 is a schematic view showing distribution of air cell zones according to a second embodiment of the present invention. According to FIG. 11 and the array below, the air cells in the air cell array 101 are divided into an E air cell zone 210, a B air cell zone 11, a C air cell zone 212, a D air cell zone 213, and an A2 air cell zone 14. In FIG. 11, a 10×10 array formed of air cells corresponds to the array below. However, those skilled in the art can understand that the array below may also represent arrays formed of other quantities of air cells. In addition, a first air passage, a second air passage, and a third air passage are provided under the air cell array 101; in which the first air passage is in connection and communication with the C air cell zone 212 and A air cell zone 214, the second air passage is in connection and communication with the B air cell zone 211 and D air cell zone 213, and the third air passage is in connection and communication with the E air cell zone 210.

$$[ \begin{matrix}E & E & E & E & E & E & E & E & E & E \\ E & E & E & E & E & E & E & E & E & E \\ A & A & A & A & A & B & B & B & B & B \\ A & A & A & A & A & B & B & B & B & B \\ A & A & A & A & A & B & B & B & B & B \\ A & A & A & A & A & B & B & B & B & B \\ D & D & D & D & D & C & C & C & C & C \\ D & D & D & D & D & C & C & C & C & C \\ D & D & D & D & D & C & C & C & C & C \\ D & D & D & D & D & C & C & C & C & C\end{matrix} ]$$

Further, in this embodiment, the pressure-regulatable pressure sores prevention cushion also has air ducts and an automatic pressure regulator or a manual inflating device, and the connection manner thereof is similar to that of the first embodiment. Moreover, in the following embodiment, description will be only related to the automatic pressure regulator, and it will be appreciated for those skilled in the art that the manual inflating device can be applied on all of the embodiments of the present invention instead of the automatic pressure regulator. Further, the microprocessor of the automatic pressure regulator can control the valve, the inflating device and the deflating device to inflate or deflate in the different air cell zones. For example, under the control of the automatic pressure regulator, the A air cell zone and C air cell zone are inflated so as to maintain high pressure, and meanwhile the B air cell zone and D air cell zone are deflated so as to maintain low pressure; such a state lasts, for example, 1-10 minutes; then, under the control of the control device, the B air cell zone and D air cell zone are inflated so as to maintain high pressure, and meanwhile the A air cell zone and C air cell zone are deflated so as to maintain low pressure; such a state lasts, for example, 1-10 minutes; then again, the A air cell zone and C air cell zone are inflated so as to maintain high pressure, and meanwhile the B air cell zone and D air cell zone are deflated so as to maintain low pressure. When the cushion is used, the E air cell zone is located under and contacts the thighs of the human body, and under the control of the automatic pressure regulator, the E air cell zone may be inflated or deflated separately with an inflating or deflating frequency and pressure different from other air cell zones; alternatively, once being inflated, the E air cell zone maintains constant pressure. During the process of inflating and deflating in the different air cell zones, the pressure can be adjusted according to the different patients; for instance, a patient himself can set and adjust the inflating or deflating pressure and duration by the regulation button on the control panel according to his moving ability and weight. Furthermore, the selectively regulation can be made by means of the parameters displayed on the display device of control panel with respected to the duration of inflating or deflating, pressure in the different air cells and the like. In the exemplary embodiment, an affordable pressure value ranged from 60 to 70 kg is set; the valve corresponding to the E air cell zone is opened by the microprocessor and the inflating device is controlled by the microprocessor to inflate the E air cell zone through the air ducts when the pressure of A air cell zone and C air cell zone is lower than 60 kg; when the pressure of E air cell zone is reached to 70 kg, the inflating device is controlled by the microprocessor to stop inflating and the valve corresponding to the E air cell zone is closed to maintain the pressure of 70 kg. Since the air may be slowly leaked, when the pressure of E air cell zone is lower than 60 kg, the inflating device is controlled by the microprocessor to re-inflate the E air cell zone to maintain the pressure of 60 to 70 kg. The description above is only the exemplary illustration of the automatic pressure regulation (or it be considered the automatic pressure inflation) in E air cell zone, the same or different inflating or deflating can be applied on the other air cell zones, and the different duration of inflating or deflating and different pressure of inflating or deflating may be configured according to the different air cell zones on the cushion. The inflating or deflating speed in different air cell zones can be a constant value or a variable value. The different air cell zones are inflated and deflated respectively as described so that the pressure is applied in an alternating manner on different parts of buttocks of a person who sits on the cushion for a long time, thereby preventing continuously applying pressure to some part of the body and reducing the occurrence probability of pressure sores.

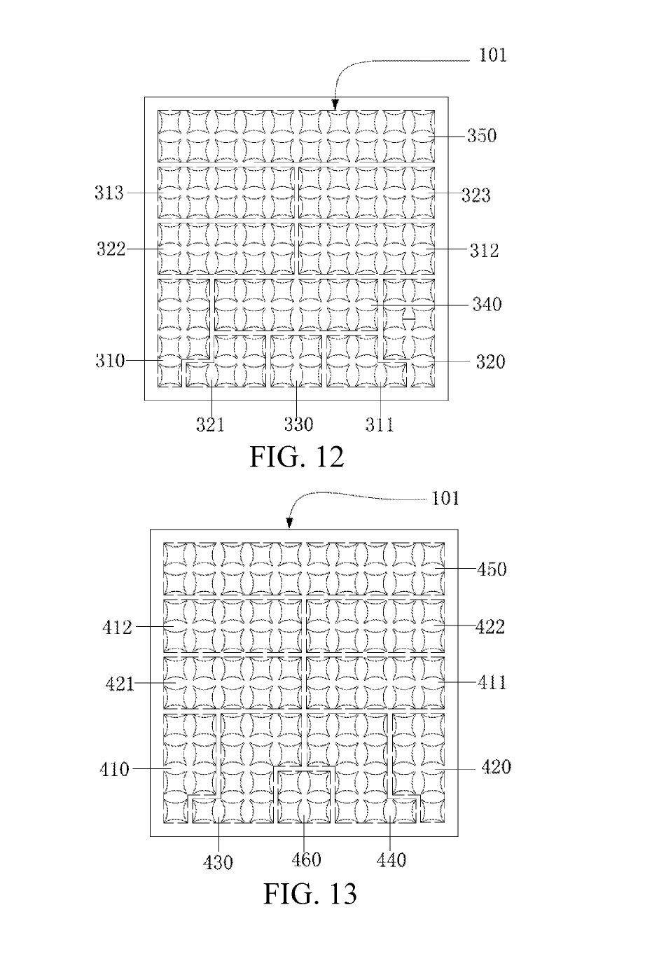

FIG. 12 is a schematic view showing distribution of air cell zones according to a third embodiment of the present invention. According to FIG. 12 and the array below, the air cells in the air cell array 101 are divided into an A1 air cell zone 310, an A2 air cell zone 311, an A3 air cell zone 312, an A4 air cell zone 313, a B1 air cell zone 320, a B2 air cell zone 321, a B3 air cell zone 322, a B4 air cell zone 323, a C air cell zone 330, a D air cell zone 340, and an E air cell zone 350. In FIG. 12, a 10×10 array formed of air cells still corresponds to the array below. However, those skilled in the art can understand that the array below may also represent arrays formed of other quantities of air cells. In addition, a first air passage, a second air passage, a third air passage, a fourth air passage, and a fifth air passage are provided under the air cell array 101. In which the first air passage is in connection and communication with the A1 air cell zone 310, the A2 air cell zone 311, the A3 air cell zone 312, and the A4 air cell zone 313; the second air passage is in connection and communication with the B1 air cell zone 320, the B2 air cell zone 321, the B3 air cell zone 322, and the B4 air cell zone 323; the third air passage is in connection and communication with the C air cell zone 330; the fourth air passage is in connection and communication with the D air cell zone 340; and the fifth air passage is in connection and communication with the E air cell zone 350.

$$[ \begin{matrix}E & E & E & E & E & E & E & E & E & E \\ E & E & E & E & E & E & E & E & E & E \\ A 4 & A 4 & A 4 & A 4 & A 4 & B 4 & B 4 & B 4 & B 4 & B 4 \\ A 4 & A 4 & A 4 & A 4 & A 4 & B 4 & B 4 & B 4 & B 4 & B 4 \\ B 3 & B 3 & B 3 & B 3 & B 3 & A 3 & A 3 & A 3 & A 3 & A 3 \\ B 3 & B 3 & B 3 & B 3 & B 3 & A 3 & A 3 & A 3 & A 3 & A 3 \\ A 1 & A 1 & D & D & D & D & D & D & B 1 & B 1 \\ A 1 & A 1 & D & D & D & D & D & D & B 1 & B 1 \\ A 1 & A 1 & B 2 & B 2 & C & C & A 2 & A 2 & B 1 & B 1 \\ A 1 & B 2 & B 2 & B 2 & C & C & A 2 & A 2 & A 2 & B 1\end{matrix} ]$$

Further, in this embodiment, the pressure-regulatable pressure sores prevention cushion also has air ducts and an automatic pressure regulator (or a manual inflating device, which is not illustrated in details), and the connection manner thereof is similar to that of the first embodiment, so that the microprocessor of the automatic pressure regulator can control the valve, the inflating device and the deflating device, thereby inflating or deflating different air cell zones. For example, under the control of the automatic pressure regulator, the A1 air cell zone, the A2 air cell zone, the A3 air cell zone, and the A4 air cell zone are inflated so as to maintain high pressure, and meanwhile the B1 air cell zone, the B2 air cell zone, the B3 air cell zone, and the B4 air cell zone are deflated so as to maintain low pressure; such a state lasts, for example, 1-10 minutes; then, the A1 air cell zone, the A2 air cell zone, the A3 air cell zone, and the A4 air cell zone are deflated so as to maintain low pressure, and meanwhile the B1 air cell zone, the B2 air cell zone, the B3 air cell zone, and the B4 air cell zone are inflated so as to maintain high pressure; inflating and deflating are performed in such an alternating manner. At the same time, the automatic pressure regulator also inflates and deflates the C air cell zone, the D air cell zone, and the E air cell zone with a certain frequency, respectively, so as to cooperate with the inflating and deflating of the A1 air cell zone, the A2 air cell zone, the A3 air cell zone, the A4 air cell zone, the B1 air cell zone, the B2 air cell zone, the B3 air cell zone, and the B4 air cell zone. The inflating and deflating frequencies and pressure of the C air cell zone, the D air cell zone and the E air cell zone may be the same or different, which can be adjusted by a user who actually uses the cushion. Moreover, once being inflated, the E air cell zone maintains constant pressure without any change. In addition, the duration of the inflating and deflating may be selectively adjusted according to parameters such as an inflating or deflating speed, a required gas volume, and intensity of pressure. Moreover, the selectively regulation can be made by means of the parameters displayed on the display device of control panel with respected to the duration of inflating or deflating, pressure in the different air cells and the like. The air cell zones are inflated and deflated frequently in an alternating manner, so that the pressures of different air cell zones are frequently changed, and the different parts of buttocks of a person who sits on the cushion for a long time are pressed in an alternating manner on, thereby preventing continuously applying pressure to a certain part of the body and reducing the occurrence probability of pressure sores.

FIG. 13 is a schematic view showing distribution of air cell zones according to a fourth embodiment of the present invention. According to FIG. 13 and the array below, the air cells in the air cell array 101 are divided into an A1 air cell zone 410, an A2 air cell zone 411, an A3 air cell zone 412, a B1 air cell zone 420, a B2 air cell zone 421, a B3 air cell zone 422, a C air cell zone 430, a D air cell zone 440, an E air cell zone 450, and a F air cell zone 460. In FIG. 13, a 10×10 array formed of air cells still corresponds to the array below. However, those skilled in the art can understand that the array below may also represent arrays formed of other quantities of air cells. In addition, a first air passage, a second air passage, a third air passage, a fourth air passage, a fifth air passage, and a sixth air passage are provided under the air cell array 101; in which the first air passage is in connection and communication with the A1 air cell zone 410, the A2 air cell zone 411, and the A3 air cell zone 412; the second air passage is in connection and communication with the B1 air cell zone 420, the B2 air cell zone 421, and the B3 air cell zone 422; the third air passage is in connection and communication with the C air cell zone 430; the fourth air passage is in connection and communication with the D air cell zone 440, the fifth air passage is in connection and communication with the E air cell zone 450; and the sixth air passage is in connection and communication with the F air cell zone 460.

$$[ \begin{matrix}E & E & E & E & E & E & E & E & E & E \\ E & E & E & E & E & E & E & E & E & E \\ A 3 & A 3 & A 3 & A 3 & A 3 & B 3 & B 3 & B 3 & B 3 & B 3 \\ A 3 & A 3 & A 3 & A 3 & A 3 & B 3 & B 3 & B 3 & B 3 & B 3 \\ B 2 & B 2 & B 2 & B 2 & B 2 & A 2 & A 2 & A 2 & A 2 & A 2 \\ B 2 & B 2 & B 2 & B 2 & B 2 & A 2 & A 2 & A 2 & A 2 & A 2 \\ A 1 & A 1 & C & C & C & D & D & D & B 1 & B 1 \\ A 1 & A 1 & C & C & C & D & D & D & B 1 & B 1 \\ A 1 & A 1 & C & C & F & F & D & D & B 1 & B 1 \\ A 1 & C & C & C & F & F & D & D & D & B 1\end{matrix} ]$$

Further, in this embodiment, the pressure-regulatable pressure sores prevention cushion also has air ducts and an automatic pressure regulator (or a manual inflating device, which is not illustrated in details), and the connection manner thereof is similar to that of the first embodiment, so that the microprocessor of the automatic pressure regulator can control the valve, the inflating device and the deflating device, thereby inflating or deflating different air cell zones. For example, under the control of the automatic pressure regulator, the A1 air cell zone, the A2 air cell zone, the A3 air cell zone are inflated so as to maintain high pressure, and meanwhile the B1 air cell zone, the B2 air cell zone, the B3 air cell zone are deflated so as to maintain low pressure; such a state lasts, for example, 1-10 minutes; then, the A1 air cell zone, the A2 air cell zone, and the A3 air cell zone are deflated so as to maintain low pressure, and meanwhile the B1 air cell zone, the B2 air cell zone, and the B3 air cell zone are inflated so as to maintain high pressure; such a state lasts, for example, 1-10 minutes; inflating and deflating are performed in such an alternating manner. At the same time, the automatic pressure regulator further inflates and deflates the C air cell zone, the D air cell zone, the E air cell zone, and the F air cell zone with a certain frequency, respectively, so as to cooperate with the inflating and deflating of the A1 air cell zone, the A2 air cell zone, the A3 air cell zone, the B1 air cell zone, the B2 air cell zone, and the B3 air cell zone. The same as the third embodiment, the inflating and deflating frequencies and pressures of the C air cell zone, the D air cell zone, the E air cell zone, and the F air cell zone in this embodiment can also be adjusted. Moreover, once being inflated, the E air cell zone maintains constant pressure, which is not changed any more. The pressures of different air cell zones frequently change, so that the pressure is in an alternating manner applied on different parts of buttocks of a person who sits on the cushion for a long time, thereby preventing continuously applying pressure to a certain part of the body and reducing the occurrence probability of pressure sores.

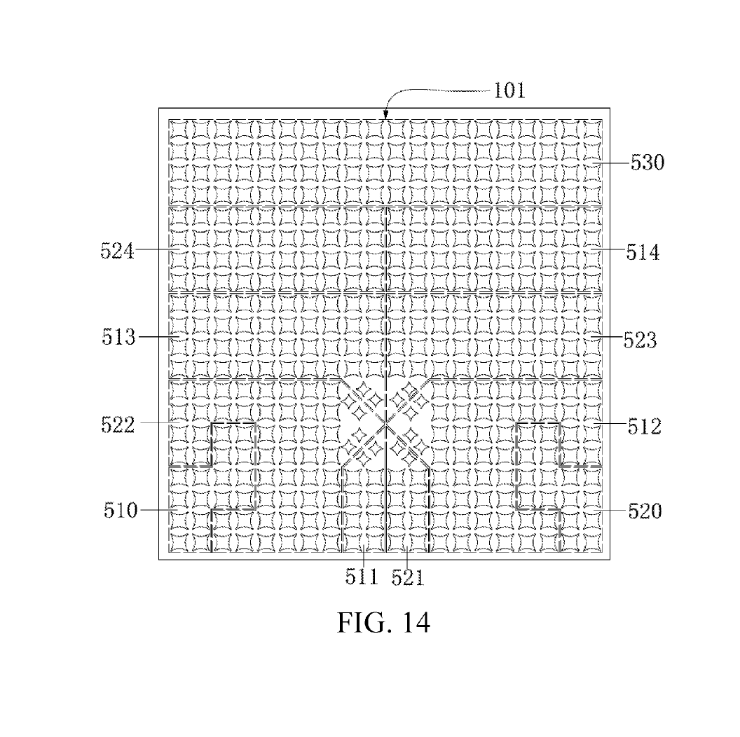

FIG. 14 is a schematic view showing distribution of air cell zones according to a fifth embodiment of the present invention. According to FIG. 14 and the array below, the air cells in the air cell array 101 are divided into an A1 air cell zone 510, an A2 air cell zone 511, an A3 air cell zone 512, an A4 air cell zone 513, an A5 air cell zone 514, a B1 air cell zone 520, a B2 air cell zone 521, a B3 air cell zone 522, a B4 air cell zone 523, a B5 air cell zone 524, and a C air cell zone 530. In FIG. 14, a 20×20 array formed of air cells corresponds to the array below, which is different from the 10×10 air cell array used in other embodiments. In other embodiments, one letter position in the array directly corresponds to an air cell, while in this embodiment one letter position in the array below corresponds to four air cells, hence forming a 20×20 air cell array. Of cause, this is merely a schematic representation, and those skilled in the art may also make one letter position in the array below correspond to other quantities of air cells, for example, three air cells, five air cells, nine air cells, and on the like. Therefore, in other embodiments, although a 10×10 array formed of air cells is taken as an example for graphical representation, but it can be understood that a 20×20 array formed of air cells, or arrays formed of other quantities of air cells can also be used for graphical representation. In addition, a first air passage, a second air passage, and a third air passage are provided under the air cell array 101; wherein the first air passage is in connection and communication with the A1 air cell zone 510, the A2 air cell zone 511, the A3 air cell zone 512, the A4 air cell zone 513, and the A5 air cell zone 514; the second air passage is in connection and communication with the B1 air cell zone 520, the B2 air cell zone 521, the B3 air cell zone 522, the B4 air cell zone 523, and the B5 air cell zone 524; and the third air passage is in connection and communication with the C air cell zone 530.

$$[ \begin{matrix}C & C & C & C & C & C & C & C & C & C \\ C & C & C & C & C & C & C & C & C & C \\ B 5 & B 5 & B 5 & B 5 & B 5 & A 5 & A 5 & A 5 & A 5 & A 5 \\ B 5 & B 5 & B 5 & B 5 & B 5 & A 5 & A 5 & A 5 & A 5 & A 5 \\ A 4 & A 4 & A 4 & A 4 & A 4 & B 4 & B 4 & B 4 & B 4 & B 4 \\ A 4 & A 4 & A 4 & A 4 & A 4 & B 4 & B 4 & B 4 & B 4 & B 4 \\ B 3 & B 3 & B 3 & B 3 & {}_{B 3}^{ }{\backslash}{}_{ }^{A 4} & {}_{ }^{B 4}{/}{}_{A 3}^{ } & A 3 & A 3 & A 3 & A 3 \\ B 3 & A 1 & B 3 & B 3 & {}_{ }^{B 3}{/}{}_{A 2}^{ } & {}_{B 2}^{ }{\backslash}{}_{ }^{A 3} & A 3 & A 3 & B 1 & A 3 \\ A 1 & A 1 & B 3 & B 3 & A 2 & B 2 & A 3 & A 3 & B 1 & B 1 \\ A 1 & B 3 & B 3 & B 3 & A 2 & B 2 & A 3 & A 3 & A 3 & B 1\end{matrix} ]$$

Further, in this embodiment, the pressure-regulatable pressure sores prevention cushion also has air ducts and an automatic pressure regulator (or a manual inflating device, which is not illustrated in details), and the connection manner thereof is similar to that of the first embodiment, so that the microprocessor of the automatic pressure regulator can control the valve, the inflating device and the deflating device, thereby inflating or deflating different air cell zones. For example, under the control of the automatic pressure regulator, the A1 air cell zone, the A2 air cell zone, the A3 air cell zone, the A4 air cell zone, the A5 air cell zone are inflated so as to maintain high pressure, and meanwhile the B1 air cell zone, the B2 air cell zone, the B3 air cell zone, the B4 air cell zone, the B5 air cell zone are deflated so as to maintain low pressure; such a state lasts, for example, 1-10 minutes; then, the A1 air cell zone, the A2 air cell zone, the A3 air cell zone, the A4 air cell zone, and the A5 air cell zone are deflated so as to maintain low pressure, and meanwhile the B1 air cell zone, the B2 air cell zone, the B3 air cell zone, the B4 air cell zone, and the B5 air cell zone are inflated so as to maintain high pressure; such a state lasts, for example, 1-10 minutes; inflating and deflating are performed in such an alternating manner. At the same time, the automatic pressure regulator further inflates and deflates the C air cell zone at a certain frequency, so as to cooperate with the inflating and deflating of the A1 air cell zone, the A2 air cell zone, the A3 air cell zone, the A4 air cell zone, the A5 air cell zone, the B1 air cell zone, the B2 air cell zone, the B3 air cell zone, the B4 air cell zone, and the B5 air cell zone. Alternatively, once being inflated, the C air cell zone maintains a constant pressure, which is not changed any more. The pressure of different air cell zones frequently changes, so that the pressure is applied in an alternating manner on different parts of buttocks of a person who sits on the cushion for a long time, thereby preventing continuously applying pressure to a certain part of the body and reducing the occurrence probability of pressure sores. The inflating and deflating frequencies and the inflating and deflating pressure of the air cell zones can be adjusted for different patients; for instance, a patient can set the inflating or deflating pressure and period according to his moving ability and weight.

The inflating and deflating states of different air cell zones in the above embodiments of the present invention are merely used to exemplarily describe the principle and efficacy of the present invention. The inflating and deflating frequencies or pressure of different air cell zones can be the same or different, and can be properly adjusted and varied in many feasible manners according to conditions of different users. In the above embodiments of the present invention, the connection manner among the plurality of air cells in the air cell zone is also diversified, and is not uniquely defined, as long as communication among the air cells in each air cell zone can be guaranteed.

Furthermore, the embodiment described-above can be provided with various types of sensors, such as pressure sensor, temperature sensor, humidity sensor and the like, wherein the pressure sensor is used to measure the pressure of the air and can be provided in the air ducts or adjacent to the valve; the pressure sensor is electrically connected with the microprocessor to transmit the measured data to the microprocessor. In addition, for certain kinds of valves that can measure the pressure, the pressure sensor may be omitted. The pressure sensor is a common technical means for those skilled in the art, and is not point of the present invention, so it is not described in detail herein.

The present invention can effectively prevent the occurrence of pressure sores. As a using example, during a process of use, when buttocks of body sit on the pressure sores prevention cushion, different air cell zones are inflated and deflated according to a requirement, and the pressure and pressure lasting period of different air cell zones are controlled, where the pressure and pressure lasting period are set according to conditions of patients, so that different parts of the buttocks are subject to same or different pressure within the same or different periods of time. When the buttocks of a patient contact are in contact with the cushion for a long time, another device can be added to blow the air cell, so as to lower the temperature and humidity on the surface of the air cell.

Further, the automatic pressure regulator can be configured with different parameters according to the different weights of bodies, when the pressure is higher than the upper limited value or lower than the lower limit value, the inflating device or deflating device is controlled to inflate or deflate the pressure-regulatable pressure sores prevention cushion. In addition, the different air cell zones can be inflate or deflate by the automatic pressure regulator pressurized in an alternating manner

The above embodiments are merely intended to exemplarily illustrate the principle and efficacy of the present invention, but the present invention is not limited to the above implementation manners. Those skilled in the art can make modifications to the embodiments without departing from the spirit and scope of the present invention and within the protection scope of the claims. Therefore, the protection scope of the present invention shall be subject to the appended claims.

What is claimed is:

1. A pressure-regulatable pressure sores prevention cushion, comprising:
an air cell array, having a plurality of air cells and being divided into at least four air cell zones, the air cells in each air cell zone being in communication with each other, but the air cells in any two adjacent air cell zones being not in communication with each other;
a plurality of air passages located under the air cell array, each of the plurality of air passages being in connection and communication with at least one of the air cell zones;
a base, on which the air cell array having the plurality of air cells and the air passages are disposed;
a plurality of air ducts disposed within the base, each air duct having an end being in communication with a corresponding air passage, and the other end extending out of the cushion and being provided with a joint; each air duct having a respective valve; and
an automatic pressure regulator which is in fluid communication with the joints of the plurality of air ducts and electrically connected to the respective valve of each duct to enable the automatic pressure regulator to inflate or deflate the respective air duct.

2. The pressure-regulatable pressure sores prevention cushion according to claim 1, wherein the automatic pressure regulator includes:
a microprocessor;
a control panel, on which a display device and a plurality of regulation buttons are disposed, the display device and the plurality of regulation buttons being electrically connected with the microprocessor; and
an inflate device and a deflate device which are electrically connected with and controlled by the microprocessor, and the inflate device and the deflate device being in fluid communication with the respective joint of the plurality of air ducts,
wherein the microprocessor is electrically connected with the respective valve of each air duct and control the open and close of the respective valve.

3. A pressure-regulatable pressure sores prevention cushion, comprising:
an air cell array having a plurality of air cells and being divided into at least four air cell zones, the air cells in each air cell zone being in communication with each other, but the air cells in any two adjacent air cell zones being not in communication with each other;
a plurality of air passages disposed under the air cell array, each air passage being in connection and communication with at least one of the air cell zones;
a base, on which the air cell array having the plurality of air cells and the plurality of air passages are disposed;
a plurality of air ducts disposed within the base, each air duct having an end being in communication with the corresponding air passage, and the other end extending out of the cushion and being provided with a joint, and each air duct having a respective valve; and
a manual inflating device which is in fluid communication with the respective joint of the plurality of air ducts to inflate the air ducts via the manual inflating device.

4. The pressure-regulatable pressure sores prevention cushion according to claim 3, wherein the manual inflating device is in fluid communication with the respective joint of the plurality of air ducts by a directional control valve.

5. The pressure-regulatable pressure sores prevention cushion according to claim 1, wherein the number of the plurality of air passages is less than the number of the air cell zones.

6. The pressure-regulatable pressure sores prevention cushion according to claim 5, wherein the air cell array is sequentially divided into four air cell zones in clockwise direction with equal area, namely, an A air cell zone, a B air cell zone, a C air cell zone, and a D air cell zone; the number of the air passages are two, namely, a first air passage and a second air passage,
wherein the first air passage is in connection and communication with the A air cell zone and the C air cell zone, and the second air passage is in connection and communication with the B air cell zone and the D air cell zone.

7. The pressure-regulatable pressure sores prevention cushion according to claim 5, wherein the air cell array is divided into an A air cell zone, a B air cell zone, a C air cell zone, a D air cell zone, and an E air cell zone as arranged in an array below; the plurality of air passages have a first air passage, a second air passage, and a third air passage;
wherein the first air passage is in connection and communication with the A air cell zone and the C air cell zone, the second air passage is in connection and communication with the B air cell zone and the D air cell zone, and the third air passage is in connection and communication with the E air cell zone; the array is:
$$[ \begin{matrix}E & E & E & E & E & E & E & E & E & E \\ E & E & E & E & E & E & E & E & E & E \\ A & A & A & A & A & B & B & B & B & B \\ A & A & A & A & A & B & B & B & B & B \\ A & A & A & A & A & B & B & B & B & B \\ A & A & A & A & A & B & B & B & B & B \\ D & D & D & D & D & C & C & C & C & C \\ D & D & D & D & D & C & C & C & C & C \\ D & D & D & D & D & C & C & C & C & C \\ D & D & D & D & D & C & C & C & C & C\end{matrix} ] .$$

8. The pressure-regulatable pressure sores prevention cushion according to claim 5, wherein the air cell array is divided into an A1 air cell zone, an A2 air cell zone, an A3 air cell zone, an A4 air cell zone, a B1 air cell zone, a B2 air cell zone, a B3 air cell zone, a B4 air cell zone, a C air cell zone, a D air cell zone, and an E air cell zone as arranged in an array below;
wherein the plurality of air passages have a first air passage, a second air passage, a third air passage, a fourth air passage, and a fifth air passage; in which the first air passage is in connection and communication with the A1, A2, A3, and A4 air cell zones, the second air passage is in connection and communication with the B1, B2, B3, and B4 air cell zones, the third air passage is in connection and communication with the C air cell zone, the fourth air passage is in connection and communication with the D air cell zone, and the fifth air passage is in connection and communication with the E air cell zone; the array is:
$$[ \begin{matrix}E & E & E & E & E & E & E & E & E & E \\ E & E & E & E & E & E & E & E & E & E \\ A 4 & A 4 & A 4 & A 4 & A 4 & B 4 & B 4 & B 4 & B 4 & B 4 \\ A 4 & A 4 & A 4 & A 4 & A 4 & B 4 & B 4 & B 4 & B 4 & B 4 \\ B 3 & B 3 & B 3 & B 3 & B 3 & A 3 & A 3 & A 3 & A 3 & A 3 \\ B 3 & B 3 & B 3 & B 3 & B 3 & A 3 & A 3 & A 3 & A 3 & A 3 \\ A 1 & A 1 & D & D & D & D & D & D & B 1 & B 1 \\ A 1 & A 1 & D & D & D & D & D & D & B 1 & B 1 \\ A 1 & A 1 & B 2 & B 2 & C & C & A 2 & A 2 & B 1 & B 1 \\ A 1 & B 2 & B 2 & B 2 & C & C & A 2 & A 2 & A 2 & B 1\end{matrix} ] .$$

9. The pressure-regulatable pressure sores prevention cushion according to claim 5, wherein the air cell array is divided into an A1 air cell zone, an A2 air cell zone, an A3 air cell zone, a B1 air cell zone, a B2 air cell zone, a B3 air cell zone, a C air cell zone, a D air cell zone, an E air cell zone, and a F air cell zone as arranged in an array below; the plurality of air passages have a first air passage, a second air passage, a third air passage, a fourth air passage, a fifth air passage, and a sixth air passage; in which the first air passage is in connection and communication with the A1, A2, and A3 air cell zones; the second air passage is in connection and communication with the B1, B2, and B3 air cell zones, the third air passage is in connection and communication with the C air cell zone, the fourth air passage is in connection and communication with the D air cell zone, the fifth air passage is in connection and communication with the E air cell zone, and the sixth air passage is in connection and communication with the F air cell zone; the array is:
$$[ \begin{matrix}E & E & E & E & E & E & E & E & E & E \\ E & E & E & E & E & E & E & E & E & E \\ A 3 & A 3 & A 3 & A 3 & A 3 & B 3 & B 3 & B 3 & B 3 & B 3 \\ A 3 & A 3 & A 3 & A 3 & A 3 & B 3 & B 3 & B 3 & B 3 & B 3 \\ B 2 & B 2 & B 2 & B 2 & B 2 & A 2 & A 2 & A 2 & A 2 & A 2 \\ B 2 & B 2 & B 2 & B 2 & B 2 & A 2 & A 2 & A 2 & A 2 & A 2 \\ A 1 & A 1 & C & C & C & D & D & D & B 1 & B 1 \\ A 1 & A 1 & C & C & C & D & D & D & B 1 & B 1 \\ A 1 & A 1 & C & C & F & F & D & D & B 1 & B 1 \\ A 1 & C & C & C & F & F & D & D & D & B 1\end{matrix} ] .$$

10. The pressure-regulatable pressure sores prevention cushion according to claim 5, wherein the air cell array is divided into an A1 air cell zone, an A2 air cell zone, an A3 air cell zone, an A4 air cell zone, an A5 air cell zone, a B1 air cell zone, a B2 air cell zone, a B3 air cell zone, a B4 air cell zone, a B5 air cell zone, and a C air cell zone as arranged in an array below; the plurality of air passages have a first air passage, a second air passage, and a third air passage; in which the first air passage is in connection and communication with the A1, A2, A3, A4, and A5 air cell zones, the second air passage is in connection and communication with the B1, B2, B3, B4, and B5 air cell zones, and the third air passage is in connection and communication with the C air cell zone; the array is:
$$[ \begin{matrix}C & C & C & C & C & C & C & C & C & C \\ C & C & C & C & C & C & C & C & C & C \\ B 5 & B 5 & B 5 & B 5 & B 5 & A 5 & A 5 & A 5 & A 5 & A 5 \\ B 5 & B 5 & B 5 & B 5 & B 5 & A 5 & A 5 & A 5 & A 5 & A 5 \\ A 4 & A 4 & A 4 & A 4 & A 4 & B 4 & B 4 & B 4 & B 4 & B 4 \\ A 4 & A 4 & A 4 & A 4 & A 4 & B 4 & B 4 & B 4 & B 4 & B 4 \\ B 3 & B 3 & B 3 & B 3 & {}_{B 3}^{ }{\backslash}{}_{ }^{A 4} & {}_{ }^{B 4}{/}{}_{A 3}^{ } & A 3 & A 3 & A 3 & A 3 \\ B 3 & A 1 & B 3 & B 3 & {}_{ }^{B 3}{/}{}_{A 2}^{ } & {}_{B 2}^{ }{\backslash}{}_{ }^{A 3} & A 3 & A 3 & B 1 & A 3 \\ A 1 & A 1 & B 3 & B 3 & A 2 & B 2 & A 3 & A 3 & B 1 & B 1 \\ A 1 & B 3 & B 3 & B 3 & A 2 & B 2 & A 3 & A 3 & A 3 & B 1\end{matrix} ] .$$

11. The pressure-regulatable pressure sores prevention cushion according to claim 6, wherein each air cell in the air cell array is a columnar air cell; the columnar air cell comprises a columnar outer casing layer and an air cell column disposed in the outer casing layer; a hydrogel layer is disposed at the top of the air cell column, and a sealing layer is disposed between the top of the air cell column and the hydrogel layer, and air is filled in space among the outer casing layer, the air cell column, and the sealing layer.
